(19) United States
(12) Patent Application Publication
(10) Pub. No.: US 2002/0135147 A1
(43) Pub. Date: Sep. 26, 2002

(54) Kick scooter steering mechanism

(76) Inventor: Guang-Gwo Lee, Taipei (TW)

Correspondence Address: Donald C. Casey, Suite 100, 311 North Washington Street, Alexandra, VA, 22314, US

(21) Appl. No.: 09/814,958

(22) Filed: Mar. 23, 2001

(51) Int. Cl. B62M 1/00

(52) U.S. Cl. 280/87.041

(57) ABSTRACT

A kick scooter steering mechanism includes a bracket fixedly fastened to the footplate of a kick scooter, a bearing structure provided at said bracket, a pivot shaft supported in the bearing structure, a steering shaft pivoted to the pivot shaft and holding two wheels at two ends, a fixed friction member provided at a bottom side of the bracket, and a spring plate supported between the steering shaft and the friction member to bear pressure from the bracket and the footplate of the kick scooter.

### BACKGROUND OF THE INVENTION

The present invent to kick scooters and, more specifically, to a steering mechanism for a kick scooter in which a spring plate is supported between the steering shaft, which supports two front wheels, and a fixed bracket, which is fastened to the footplate of the kick scooter, to limit sideways biasing of the footplate to a limited angle and, to automatically return the footplate to the balanced horizontal position after disappearance of the external sideways pressure.

A regular kick scooter, for example, the disclosure of U.S. Pat. No. 5,853,182A, comprises tilted pivot means provided at the bottom side of the footplate, and a steering shaft pivoted to the tilted pivot means to support front wheels. The pivot means is disposed in line with the vertical center of the footplate. When the footplate receives a sideways pressure, it will be forced to turn with the pivot means and biased in one direction. In order to stop the footplate from biasing when turning with the pivot means, spring means is provided to support the pivot means. When the pivot means turns with the footplate, the spring means receives a torsional force from the pivot means. Because the spring means frequently receives a torsional force from the pivot means during steering of the kick scooter, it wears quickly with use and, tends to be damaged.

### SUMMARY OF THE INVENTION

The present invention has been accomplished to provide a kick scooter steering mechanism, which eliminates the aforesaid problem. It is the main object of the present invention to provide a kick scooter steering mechanism, which enables the kick scooter to be moved forwards smoothly when biased to change its steering direction. It is another object of the present invention to provide a kick scooter steering mechanism, which keeps the steering shaft in balance when the footplate is biased. According to one aspect of the present invention, the kick scooter steering mechanism comprises a bracket fixedly fastened to the footplate of a kick scooter, a bearing structure provided at said bracket, a pivot shaft supported in the bearing structure, a horizontally extended steering shaft pivoted to the pivot shaft and holding two wheels at two ends, a fixed friction member provided at a bottom side of the bracket, and a spring plate supported between the steering shaft and the friction member to bear pressure from the bracket and the footplate of the kick scooter. According to another aspect of the present invention, the spring plate is supported between two bearings at two ends of the steering shaft, and a friction member is fixedly connected to the bracket and disposed in contact with the top sidewall of the spring plate. The friction member works as a cam, which turns with the footplate and acts against the spring plate when the footplate is biased sideways. Therefore, the steering shaft is constantly maintained in balance when the footplate is biased to change the steering direction of the kick scooter.

### BRIEF DESCRIPTION OF THE DRAWINGS

FIG. 1 is a sectional view of a steering mechanism constructed according to a first embodiment of the present invention.

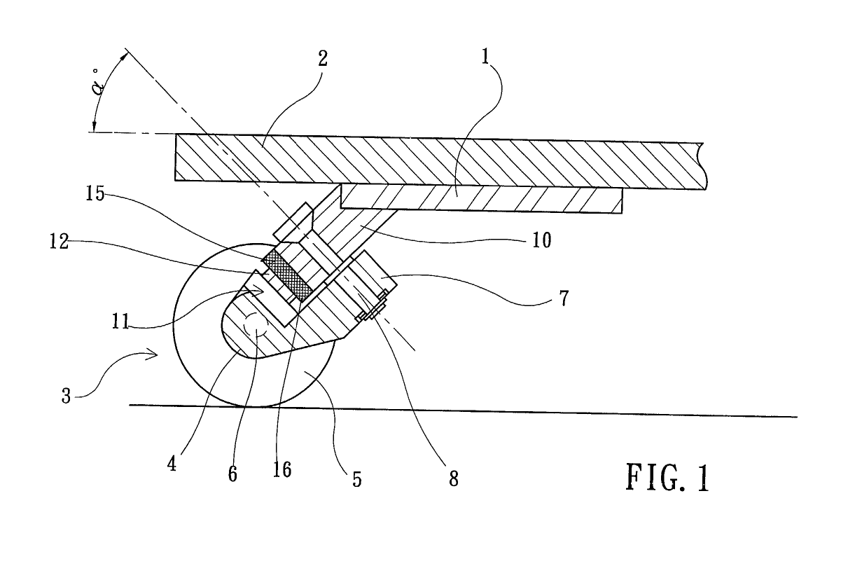

FIG. 2 is a front plain view of the first embodiment of the present invention.

FIG. 3 is another front plain view of the first embodiment of the present invention, showing the mounting plate and the bracket biased relative to the steering shaft.

FIG. 4 is a sectional view of a steering mechanism constructed according to a second embodiment of the present invention.

### DETAILED DESCRIPTION OF THE PREFERRED EMBODIMENT

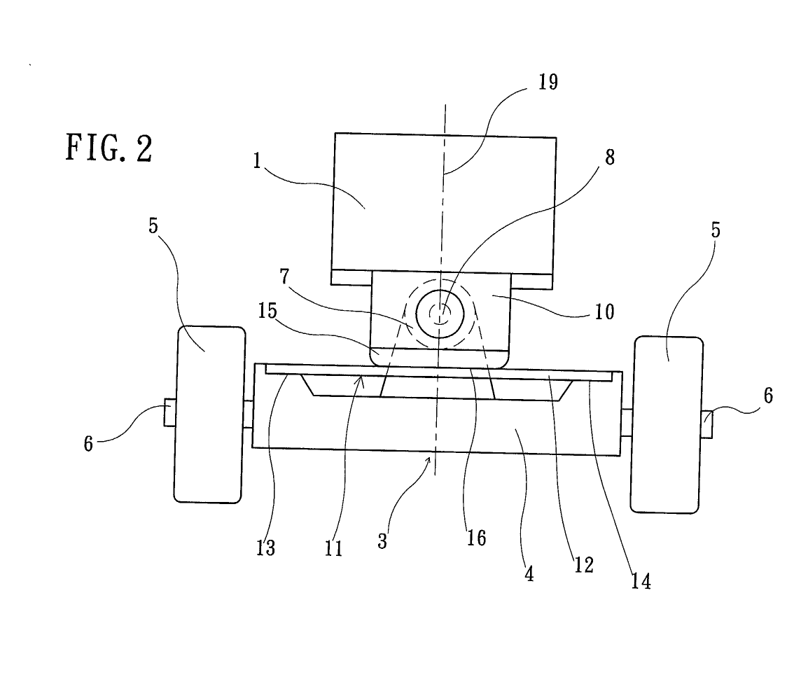

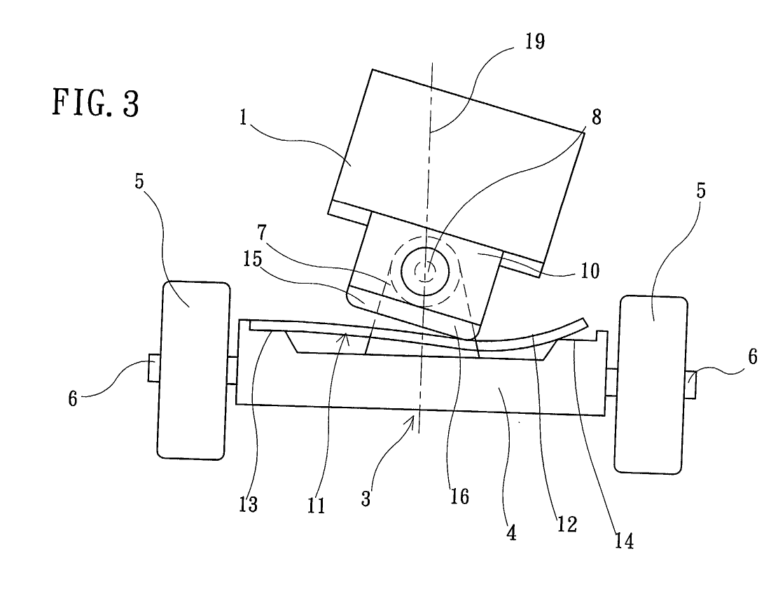

Referring to FIGS. from 1 through 3, a steering mechanism 3 is mounted on a fixed mounting plate 1 at the bottom side of the footplate 2 of a kick scooter. The steering mechanism 3 comprises a bracket 17 fixedly fastened to a bottom flange 10 of the mounting plate 1, a bearing structure 7 provided at the bracket 17, a pivot shaft 8 supported in the bearing structure 7, a steering shaft 4 pivoted to the pivot shaft 8, the steering shaft 4 having two round rods 6 at two ends thereof, and two front wheels 5 respectively revolvably supported on the round rods 6. The bracket 7 is disposed in a tilted position, i.e., tilted at an angle α relative to the footplate 2 of the kick scooter. When imparting a pressure to one side of the footplate 2, the footplate 2 is turned with the mounting plate 1 and the bracket 17 about the pivot shaft 8 relative to the steering shaft 4 through an angle and biased from the vertical line 19. In order to stop the steering shaft 4 from biasing when the footplate 2 turns with the mounting plate 1 and the bracket 17 about the pivot shaft 8 relative to the steering shaft 4 through an angle, spring means 11 is used. According to the present preferred embodiment, the spring means 11 comprises a spring plate 12 supported on a fixed axle bearing 13 at one end of the steering shaft 4 and a movable axle bearing 14 at the other end of the steering shaft 4 (see FIGS. 2 and 3). The top surface of the spring plate 12 is disposed in contact with a friction member 15 being fixedly provided at the bottom flange 10 of the mounting plate 1. The friction member 15 has a bottom contact surface 16 disposed in contact with the spring plate 12. When the footplate 2 receives no pressure, the footplate 2 is kept in horizontal, and the bottom contact surface 16 of the friction member 15 is disposed in parallel to the steering shaft 4. When the footplate 2 turns with the mounting plate 1 and the bracket 17 about the pivot shaft 8 relative to the steering shaft 4 through an angle, the friction member 15 is forced against the spring plate 12, causing the spring plate 12 to deform. After the pressure released from the footplate 12, the spring plate 12 immediately returns to its former shape, forcing the friction member 15, the mounting plate 1, and the footplate 2 back to the horizontal position.

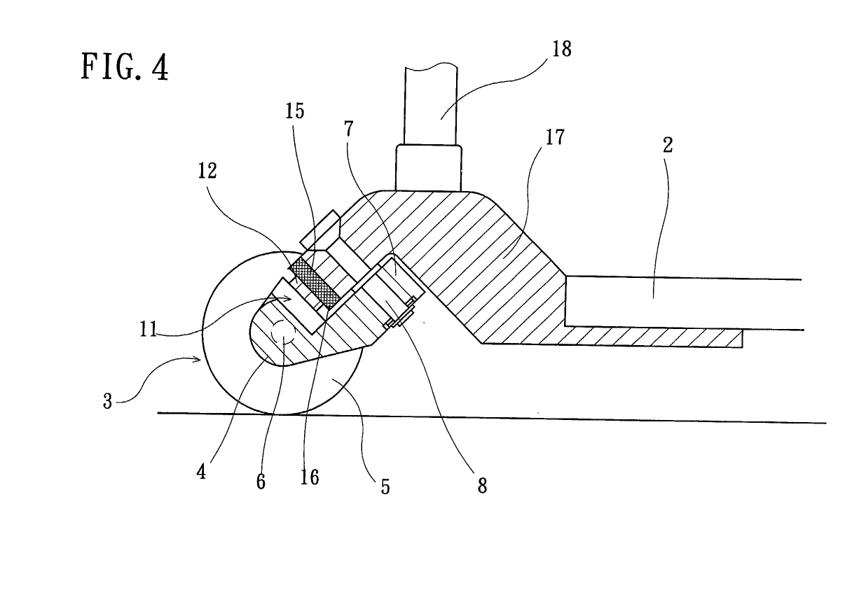

FIG. 4 shows an alternate form of the present invention. According to this alternate form, the bracket 17 is directly fixedly fastened to the footplate 2, and a steering column 18 is fixedly vertically fastened to the bracket 17 at the topside. The steering column 18 can be made collapsible. When not in use, the steering column 18 is unlocked and turned to the collapsed position closely attached to the footplate 2. When in use, the steering column 18 is turned to the vertical operative position and then locked in the operative position.

A prototype of kick scooter steering mechanism has been constructed with the features of the annexed drawings. The kick scooter steering mechanism functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A kick scooter steering mechanism comprising a bracket fixedly fastened to the footplate of a kick scooter, a bearing structure provided at said bracket, a pivot shaft supported in said bearing structure, a steering shaft pivoted to said pivot shaft and holding two wheels at two ends, wherein a fixed friction member is provided at a bottom side of said bracket, and a spring means is supported between said steering shaft and said friction member to bear pressure from said bracket and the footplate of the kick scooter.

2. The kick scooter steering mechanism of claim 1 wherein said spring means comprises a spring plate supported between two bearings at two ends of said steering shaft and disposed in contact with said friction member to bear the pressure from said bracket and the footplate of the kick scooter.

3. The kick scooter steering mechanism of claim 1 wherein said friction member has a bottom contact surface disposed in contact with said spring plate, said bottom contact surface being disposed in parallel to said steering shaft when said friction member is kept in horizontal.
